(19) United States
(12) Patent Application Publication
(10) Pub. No.: US 2004/0166198 A1
(43) Pub. Date: Aug. 26, 2004

(54) Process for the manufacture of a fermented health-promoting product

(76) Inventors: Jeroen Lucas Kiers, Den Haag (NL); Martinus Johannes Robertus Nout, Wageningen (NL); Franciscus Maria Rombouts, Heteren (NL)

Correspondence Address: Young & Thompson, Second Floor, 745 South 23rd Street, Arlington, VA, 22202, US

(21) Appl. No.: 10/475,985

(22) PCT Filed: Apr. 24, 2002
(86) PCT No.: PCT/NL02/00272

(30) Foreign Application Priority Data
Apr. 25, 2001 (EP) 01201510.3

(51) Int. Cl. A23K 1/00

(52) U.S. Cl. 426/49

(57) ABSTRACT

The present invention relates to a process that yields a product that can suitably be used in the treatment and prevention of diarrhea without giving rise to any undesirable side-effects. The invention is based on the discovery that aqueous fractions obtained from the fermentation of certain plant materials with fungi, may effectively be used to prevent, manage and/or treat diarrhea. Thus, in one aspect, the invention relates to a process for the manufacture of a health promoting product, said process comprising the subsequent steps of: a) preparing a substrate containing from 30 to 60 wt. % dry matter of which at least 50 wt. % is derived from a plant material selected from legume, pulses, fruit, nuts, beans, seeds, grain, tubers and mixtures thereof, said substrate containing between 7.5 and 70% protein, between 20 and 67% carbohydrates and less than 40% lipids by weight of dry matter, b) inoculating said substrate with a specified fungus, c) allowing the fungus to ferment the substrate for at least 6 hours at a temperature in excess of 25° C., d) isolating an aqueous fraction from the fermentate so obtained, e) drying said aqueous fraction so as to obtain a powder which expresses at least 10 U/g of protease activity. Another aspect of the present invention relates to a composition for use in a method of treating diarrhea, wherein said method comprises administering an effective amount of a powder obtained by the process as described above.

### TECHNICAL FIELD

The present invention is concerned with a process for the manufacture of a health promoting product, said process comprising the fermentation of a plant material containing substrate by means of one or more fungi. The invention also encompasses compositions for use in a method for the (prophylactic) treatment of diarrhea which method comprises administering an effective amount of the product of the aforementioned fermentation process.

### BACKGROUND OF THE INVENTION

Diarrhea is an intestinal disorder characterised by abnormal fluidity and frequency of stool output, generally the result of increased motility in the colon. During diarrhea there is an increased loss of water and electrolytes (sodium, chloride, potassium and bicarbonate) in liquid stool. Dehydration occurs when these losses are not replaced adequately. This occurs because food is frequently not tolerated and passes the gastrointestinal tract rapidly. Diarrhea is therefore often associated with nutritional deficits. The occurrence of diarrhea is not limited to specific parts of the world or to specific human subpopulations. Diarrhea can be fatal for infants, diseased persons and elderly persons. Animals (both farm animals and pet animals) can also serious suffer from diarrhea.

Diarrhea can be caused by various conditions. Consumption of intoxicated or microbially impure foods or beverages (“traveller's diarrhea”) or unbalanced diets (such as exclusively liquid or incomplete food or food having high osmotic values or sudden changes in food composition (weaning)) in human nutrition or reduced feed intake leading to post-weaning diarrhea in livestock breeding. Diarrhea is enhanced by reduced resistance as in some diseased states (cancer, HIV) or after certain therapies (antibiotics, chemotherapy, radiotherapy) or malnutrition. Diarrhea can be a side effect of other diseases, such as Crohn's disease, inflammatory bowel disease. In livestock-breeding, diarrhea is a major problem due to the high population density and concomitant infection pressure.

Pathogens most strongly associated with acute infectious diarrhea in children are rotavirus, Shigella spp. and enterotoxic Escherichia coli (ETEC) [Huilan et al. “Etiology of acute diarrhea among children in developing countries; a multicentre study in five countries”, Bulletin of the World Health Organization 1991, 69: 549-555].

The course of infectious diarrhea caused by Escherichia coil toxins (E. coil produces heat labile toxin (LT) and heat stable toxin (ST)) is very similar to cholera toxin (CT): first the pathogen needs to bind to small intestinal mucosa, then the pathogen colonises, starts to secret toxins, after which the toxins are transported into the cell and cause increased secretion of water and electrolytes.

A vast amount of knowledge has been accumulated about the mechanisms of attachment and the role of enterotoxins in pathogenesis of enterotoxigenic Escherichia coil (ETEC) infections. Despite this knowledge, completely safe and effective prophylaxis against ETEC diarrhea or treatments that can counteract the large fluid losses sometimes observed, are unavailable. Several studies have shown the efficacy of antimicrobial drugs such as doxycycline and trimethoprim/sulfamethoxazole in prophylaxis of traveller's diarrhea. However, use of these agents has been associated with undesirable side-effects, including hypersensitivity reactions, and these agents are not always effective because of the rapid emergence of drug resistant flora in the intestines of these patients. Subsalicylate bismuth provides partially effective prophylaxis against traveller's diarrhea. However, objectionable taste, constipation, and nausea are observed in patients taking the liquid formulation. In addition, many travellers find carrying large amounts of liquid medication inconvenient. Current means of treating diarrheal diseases centre around the application of synthetic opiates such as loperamide and alkaloids. However also these synthetic pharmaceuticals exhibit a number of undesirable side effects.

U.S. Pat. No. 5,885,632 (Takebe et al.) describes a process for preparing a product from a pulse crop by preparing a koji preparation by steps comprising cooking said pulse crop, cooling said pulse crop and adding water and koji starter, hydrolysing said koji preparation, thereby forming isoflavone compounds containing aglycones. The products so obtained are claimed to have excellent carcinopreventive and carcinostatic activities, osteoporosis therapeutic effect and immunosuppressive effect.

WO 94/00147 (Cortecs Ltd.) is concerned with the use of an enzyme in the manufacture of a medicament for the prevention, management or treatment of diarrhoea in humans. According to this document proteolytic enzymes, and bromelain in particular, are effective in inhibiting the action of heat-labile toxin of enterotoxigenic Escherichia coli. The use of such enzymes to prevent, manage or treat infectious diarrhoea caused by heat labile toxins, heat stable toxins, ETEC and Vibrio cholerae is mentioned. In the application it is noted that it may be desirable to formulate the enzyme in an enteric-protected preparation so as to assist survival of the proteolytic enzyme through the stomach.

U.S. Pat. No. 6,194,379 (Mc Ewen et al.) relates to liquid nutritional products comprising a protein system that contains from about 40 w/w % to about 90 w/w % of soy protein hydrolysate, at least one lipid providing from about 10% to about 25% of the total calories of the product and at least one carbohydrate. These products can suitably be used to provide nutrition to a patient having a malabsorption condition by enterally feeding to the patient the aforementioned liquid product.

Karyadi et al. Nutrition Reviews, Vol. 54, No. 11 (November 1996) S94-S98 describe the beneficial effects of tempeh in disease prevention and treatment. Tempeh is a fermented soy food originally developed in Central Java, Indonesia. According to the article the three basic steps in tempeh preparation are: soaking, boiling and fermentation. The article reports that recent studies have shown potential roles for soy foods in the prevention and treatment of chronic, non-communicable diseases, most notably cancer and heart disease. On page 96 the results of an investigation of the effects of tempeh-formulated food on the growth rate of children aged 6-24 months suffering from diarrhea are discussed. This study is said to have revealed the beneficial effects of tempeh-formulated food on the duration of diarrhea, body weight gain, and nutritional status.

### SUMMARY OF THE INVENTION

The present invention relates to a process that yields a product that can suitably be used in the treatment and prevention of diarrhea without giving rise to any undesirable side-effects. Such treatment also alleviates the accompanying effects of diarrhea such as abdominal pains, cramps, dehydration, feelings of weakness etc. The invention is based on the discovery that aqueous fractions obtained from the fermentation of certain plant materials with fungi, may effectively be used to prevent, manage and/or treat diarrhea. Best results are obtained if these fractions express significant protease activity. The present process includes a drying step that yields a stable product that still expresses substantial protease activity.

The product obtained by the present process can suitably be used in the treatment of diarrhea. Throughout this application the term treatment should be read to also encompass prophylactic treatment. The powders obtained by the present process offer the advantage that they can be obtained as 100% natural concentrated powders that are easy to handle. These powders can be stored at ambient conditions for prolonged periods of time. In addition, they are easily dissolvable in water and can thus suitably be used in oral rehydration solutions such as those well known in the art.

### DETAILED DESCRIPTION OF THE INVENTION

The present invention is specifically concerned with a process for the manufacture of a health-promoting product, said process comprising the consecutive steps of:

a) preparing a pasteurised or sterilised substrate containing from 30 to 60 wt. % dry matter of which at least 50 wt. % (of the dry weight) is derived from a plant material selected from the group consisting of legume, pulses, fruit, nuts, beans, seeds, grain, tubers and mixtures thereof, said substrate containing between 7.5 and 70% protein, between 20 and 67% of digestible carbohydrates and between 0 and 40% lipids by weight of dry matter,

b) inoculating said substrate with a fungus from a genus selected from the group consisting of Rhizopus, Aspergillus, Mucor, Penicillium, Alomyces, Absidia and Syncephalastrum,

c) allowing the fungus to ferment the substrate for at least 6 hours at a temperature in excess of 25° C.,

d) isolating an aqueous fraction from the fermentate so obtained,

e) drying said aqueous fraction so as to obtain a flowable powder which expresses at least 10 U/g of protease activity.

The substrate used in the present process must be pasteurised or sterilised prior to inoculation as otherwise contamination with bacteria and/or yeast may occur. Also, by carrying out a heat pasteurisation or sterilisation, the plant material is usually ‘cooked’, which causes any starch material contained therein to gelatinise and swell and makes it more easy digestible to both micro-organisms and mammals; such cooking also inactivates endogenous plant enzymes. Therefore, the substrate is preferably subjected to a temperature of at least 60° C., preferably at least 90° C., in particular during pasteurisation or sterilisation. Hulls and other plant parts that have little or no nutritional value are preferably removed from the plant material before it is incorporated in the substrate.

It is important that the substrate contains less than 70 wt. %, more preferably between 50 and 66 wt. % water as higher moisture levels increase the risk of bacterial growth. Bacterial growth will lead to a product that does not display the desired properties or a product that may even induce diarrhea rather than preventing or curing it. The fermentation may be carried out as a solid state or as a specific submerged fermentation. Solid state fermentation can be defined as a technique for growing micro-organisms, such as fungi, yeasts and bacteria, on moist solid substrates, as contrasted to so-called submerged fermentations wherein these same micro-organisms are allowed to grow whilst being kept in aqueous suspension. It is essential that the present fermentation is carried out under aerobic conditions. In case of submerged fermentation this requires continuous agitation and/or aeration. In order to avoid that this will lead to inactivation of the fungus, it can be advantageous to apply a submerged fermentation in which substrate and fungi together form aggregate particles which are kept in suspension during agitation and/or aeration. Preferably the fermentation step in the present process is carried out as a solid state fermentation.

In a preferred embodiment of the present invention at least 60 wt. % of the dry matter of the substrate is derived from the plant material as defined above. More preferably, the substrate dry matter comprises at least 75 wt. %, up to 100%, of dry matter derived from said plant material. It should be understood that the substrate used in step a) of the process may suitably be obtained from plant materials that display high water contents by subjecting such materials to one or more drying steps as part of the preparation of the substrate. As a matter of fact it can also be convenient to utilise dried plant materials and to rehydrate such materials to a sufficient moisture content for carrying out the present process.

The substrate to be used in step a) preferably contains between 15 and 60, more preferably between 20 and 40% protein, between 22 and 49% of digestible carbohydrates and between 1 and 10% lipids, by weight of dry matter of the substrate. Digestible carbohydrates are those carbohydrates that can be broken down by the mammalian enzyme system, absorbed and metabolised. They include e.g. glucose and fructose, sucrose and lactose, as well as glucose-based di-, oligo- and polysaccharides such as maltose, malto-dextrins and starch They do not include fermentable and non-fermentable dietary fibres, although these may be, and preferably are present in the substrate.

In order for the fermentation process to start up quickly, it is advantageous to inoculate with at least 100,000, preferably at least 1 million spores per 100 grams of substrate. The fermentation process is preferably carried out a temperature in the range between 30 and 45° C., more preferably in the range between 32 and 42° C. In another preferred embodiment the substrate is fermented for at least 12 hours.

The isolation step (d) may be carried out by any suitable isolation means know in the art, provided said isolation means effectively separate non-dissolved solids from the supernatant liquid. Examples of suitable filtration techniques are: filtration, centrifugation and decanting. Naturally such decanting should only occur after most solids have been allowed to form a sediment. The isolation method applied in the present process preferably yields a supernatant liquid that contains less than 10 wt. %, more preferably less than 5 wt. % undissolved solids. It is noted that prior to isolating the aqueous fraction, it may be beneficial to add some water, in particular if the isolation technique includes filtration. Generally, however, the isolated aqueous fraction will contain less than 80% added water by weight of the total amount of water present in said fraction.

It is noted that present process also encompasses an embodiment wherein the fermented substrate is dried, subsequently diluted again with water, after which the aqueous fraction is isolated and dried again. This embodiment of the invention may be advantageous if the downstream processing of the fermented substrate is to occur at another location.

The isolated aqueous fraction may be pasteurised or sterilised prior to the drying step. Naturally pasteurisation/sterilisation conditions should be chosen here such that the (fungal) protease activity present in the isolated aqueous fraction is largely retained. A particularly advantageous way of achieving this is to apply a filtration step that effectively removes all micro-organisms, but not the (high molecularly molecules dissolved in the isolated fraction.

The drying step may suitably involve techniques such as freeze drying, spray drying and drum drying, especially the latter being carried out so as to avoid excessive temperatures. The drying process as applied in the present process yields a powder. A. prerequisite to the drying process is that it will not lead to loss of a significant fraction of the protease activity present in the isolated aqueous fraction. Preferably the protease activity, calculated on dry matter, is reduced by no more than 30% as a result of the drying process. Preferably the drying step employed in the present process is spray drying or freeze drying. Most preferably the present process employs a spray drying step, wherein the temperature of the spray-dried particles does not exceed 75° C. as can be achieved by applying the method of NL-A-1016981.

Expression of sufficient protease activity is important as it is believed that proteases, in particular in combination with other components contained by the dried aqueous fraction, can play an important role in preventing and treating diarrhea. As described above, infectious diarrhea, such as dairrhea caused by ETEC infection, is thought to be initiated by the secretion of toxins by the pathogenic micro-organism. These toxins are polypeptides that may be degraded by the proteases in the dried aqueous fraction obtained by the present process. Thus by inactivating these toxins, the powder obtained by the process of the invention may advantageously be used to prevent or cure infectious diarrhea. It is also possible that said advantageous effect is the result of proteases, and possibly other constituents of the present powder, inhibiting the binding of toxins or pathogens to the mucosa epithelium.

It is a critical element of the present process that the fermentation is carried out by means of a fungus. According to a preferred embodiment of the present process, the fungus used to inoculate the substrate is selected from the group consisting of Rhizopus microsporus (especially varieties microsporus, oligosporus and rhizopodifornis), Rhizopus stolonifer, Rhizopus oryzae (also referred to as Rhizopus arrhizus), Rhizopus japonicus, Rhizopus formosaensis, Aspergillus niger (especially variety awamori), Aspergillus soyae, Aspergillus oryzae, Aspergillus phoenicis, Mucor javanicus, Mucor racemosus, Mucor hiemalis, Mucor indicus, Mucor circinelloides, Penicillium glaucum and Penicillium fuscum. More preferably the fungus is selected from the group consisting of: Rhizopus microsporus, Rhizopus stolonifer, Rhizopus oryzae, Aspergillus niger, Mucor javanicus and Mucor indicus.

In another preferred embodiment of the invention the substrate is inoculated with a mixture of at least 2 different fungi. By applying a mixture of fungal strains, very good results can be obtained, particularly in terms of process yield and reliability.

The present process can suitably employ substrates derived from a variety of plant materials. Best results are obtained if the plant material used in the preparation of the substrate is selected from the group consisting of pulse, grain and mixtures thereof. More preferably the plant materials is pulse. Most preferably the plant material is soy, cowpea or a mixture of these two pulses.

The process of the invention is very different from the fermentation process employed in the preparation of soy sauce. The latter process does not yield a fermented product displaying the protease activity observed in the aqueous fraction. Also the process of preparing soy sauce always includes the step of adding a brine solution typically containing from 22 to 25 wt. % sodium chloride. Preferably no salt is added to the substrate used in the process according to the invention, and thus it will contain less than 5 wt. %, more preferably less than 2 wt. % sodium chloride. The ready-to-use product of the present invention will usually contain between 0.06 and 2 wt. %, preferably between 0.1 and 1 w.t % of sodium chloride.

The dried aqueous fraction obtained by the present process preferably contains from 35 to 90 wt. % proteinaceous matter, from 10 to 45 wt. % carbohydrates, less than 8 wt. % lipids and less than 10 wt. % water. More preferably the dried aqueous fraction contains from 40 to 70 wt. % proteinaceous matter and from 15-35 wt. % carbohydrates.

It was found that of the material contained in the dried fraction, the bigger than 5 kD portion is particularly effective in the treatment of diarrhea. Hence, in a preferred embodiment, the bigger than 5 kD portion of the dried fraction represents at least 15 wt. %, more preferably at least 25 wt. % of said dried fraction. The bigger than 5 kD portion in the dried fraction comprises high molecular weight components such as proteins, polysaccharides, glycoproteins and lipoproteins. The concentration of the bigger than 5 kD portion is suitably determined by diluting the dried fraction and passing it over an ultra-filtration membrane with a molecular weight cut-off of 5000 Dalton. It is noted that such membranes do not exhibit the same cut-off point for all types of molecules and samples, and that commercially available filters with the same molecular weight cut-off point may not necessarily produce exactly the same result. This is why the concentration of the bigger than 5 kD portion as present in the dried fraction is to be determined with the help of a Koch Spiral module, type S2K328, or with a filter having similar cut-off properties.

For certain applications it can be highly advantageous to apply a powder displaying anti-diarrhea properties as obtained by the present process in a concentrated form. We have found that particularly the high molecular materials contained in the isolated aqueous fraction, is effective in the treatment of diarrhea. Hence in a preferred embodiment of the present process, the isolation step d) includes the application of a filter with a molecular weight cut-off point that is such that the fraction of molecules of a MW above 3 kD is enriched in the aqueous fraction. It may be noted in this respect, that a commercial filter having a nominal cut-off value of 5 kD may in fact separate at values of about 3 kD, so that such filters may be advantageously used in the process of the invention.

The dried aqueous fraction obtained by the present process is characterised in that it expresses at least 10 U/g protease activity, preferably at least 15 U/g. Although the inventors do not wish to be bound by theory, it is believed that the effectiveness of the dried aqueous fraction against diarrhea is derived from the combined presence of proteases and other anti-diarrhea components. In particular the combined presence of proteases, glycosidases, and polysaccharides is believed to be responsible for the effectiveness of the dried fraction against diarrhea. However, oligosaccharides and free amino acids, including alanine, were also found to beneficial in the anti-diarrhea treatment, and therefore use of the whole aqueous fraction, without molecular weight separation, or exceptionally only the low molecular weight fraction may also be used.

The protease activity in the dried fraction obtained by the present process is suitably measured using TNBS (2,4,5-trinitrobenzenesulphonic acid). During protein hydrolysis a peptide bond is cleaved resulting in the formation of a free amino group. The increase in amino groups can be determined with TNBS and is a measure for proteolytic activity. For this assay 30 milligrams of dried fraction is dissolved in 1 ml water. 100 μl of the solution so obtained is mixed with 100 μl 1% casein solution in 50 mM phosphate buffer (pH 6.5) and incubated at 37° C. for 1 hour. The reaction was stopped by heating the reaction mixture for 15 minutes at 100° C. in boiling water. The sample was filtered over a 0.2 μm filter and diluted 10 times with 1% SDS (sodium dodecyl sulfate). From this mixture 15 μl was mixed with 45 μl of 0.2M phosphate buffer (pH 8.2) and 45 μl TNBS solution (0.05% w/v) in a 96 wells plate and incubated for 1 hour at 50° C., after which 90 μl of 0.1 M HCl was added. The absorption of the sample was measured at 340 nm against a blanc. For the blanc 100 μl of inactivated (by boiling for 15 minutes) solution of dried fraction was prepared in the same way as described above. Several leucine solutions of known concentrations were used as standards. Using these standards the proteolytic activity was calculated as U/g (μmol.min⁻¹.g⁻¹). One protease unit is defined as the amount of material (dried fraction) which liberates 1 μmol of amino groups per minute.

Glycosidases may be able to modify the lipopolysaccharide (LPS) complex on the outer envelope of gram negative bacteria such as ETEC. The LPS complex participates in a number of outer membrane functions that are essential for bacterial growth and survival and plays an important role in the interaction of the pathogen with its host as an adherence factor (colonisation). Due to the modification of this lipopolysaccharide the pathogenic bacteria may be unable to adhere to the epithelial cells and to initiate the process which leads to diarrhea. The dried aqueous fraction of the invention preferably expresses at least 4.5 U/mg glycosidase activity, meaning that it expresses at least 4.5 U/mg combined activity of α-galactosidase, β-galactosidase, α-glucosidase, β-glucosidase. More preferably said dried fraction expresses at least 4.5 U/mg of α-galactosidase activity. Most preferably the α-galactosidase activity exceeds 7.5 U/mg.

The glycosidase activity of the dried fraction can suitably be measured with a colorimetric assay using different types of para-nitrophenyl-linked substrates, for example para-nitrophenyl-α-D-galactopyranoside (pNPαGal) where a D-galactose is linked with a para-nitrophenol (pNP) molecule with an α-galactoside bond. Enzymatic hydrolysis of the pNPαGal molecule liberates the pNP, which can be determined spectrophotometrically. The glycosidase activity values presented in the examples below were determined for α-galactosidase, β-galactosidase, α-glucosidase and β-glucosidase. The substrates used were 0.1% para-nitrophenyl-α-D-galactopyranoside (Sigma, N-0877, lot 36h5007), 0.1% para-nitrophenyl-β-D-galactopyranoside (pNPβGal) (Sigma N-1252, lot 15h5017), 0.1% para-nitrophenyl-α-D-glucopyranoside (pNPαGlu) (Signa N-1377, lot 25h3276), and 0.1% para-nitrophenyl-β-D-glucopyranoside (pNPβGlu) (Sigma N-1627, lot 30k1752).

To measure the glycosidase activity, 25 μl of a 30 mg/ml aqueous solution of the dried fraction is combined with 75 μl phosphate buffer (pH 6.5) and 25 μl 0.1% substrate solution and added in a well of a 96-well microtitre plate and incubated for 1 hour at room temperature. Then the reaction is stopped by adding 125 μl NaOH to the solution in the well. The formed pNP was measured with a microtitre plate reader (SpectraCount) at 405 nm. Concentration of the formed pNP was calculated using a standard curve of pNP. The enzymatic activity, in units, can be calculated therefrom. One unit of enzyme activity is defined as the amount of material (dried fraction) liberating 1 μmole of pNP per minute.

Polysaccharides have been reported to inhibit the adherence of pathogens. The aqueous fraction obtained by the process of the present invention contains significant amounts of polysaccharides, which may either have been present as such in the original substrate or have been formed by hydrolysis of polysaccharides and/or glycosides, such as glycoproteins, during the fermentation step. The dried fraction obtained by the present process preferably contains at least 10 wt. % polysaccharides, more preferably between 15 and 35 wt. % polysaccharides. As used herein the term polysaccharides refers to saccharides that comprise more than 20 sugar (monosaccharide) units.

It was found that in case the substrate used in the present process is based on pulses, ingestion of the resulting dried powder does not lead to flatulence. This is surprising as consumption of soy based foods is usually associated with flatulence. This is due to the presence of saccharides containing α-galactose units, such as raffinose, stachyose. Such saccharides are not digested directly by animals, primarily because α-galactosidase is not present in the intestinal mucosa. However, microflora in the lower gut are readily able to digest the raffinose saccharides which results in an acidification of the gut and production of carbon dioxide, methane and hydrogen. It is believed that due to the α-galactosidase activity which is developed during the fermentation step, raffinose saccharides are pre-digested. As a result the powders obtained by the present process offer the advantage that, even when derived from a plant material that contains substantial amounts of raffinose or other α-galactose-terminated saccharides, their ingestion does not lead to significant flatulence.

During the fermentation step of the present process, the proteases formed will digest some of the proteinaceous matter available in the substrate. This leads to the formation of oligopeptides which are subsequently hydrolysed by peptidases which are also naturally present in the fermentate obtained in the present process. As a result of the combined presence of proteases and peptidases, the dried aqueous fraction normally contains at least 8% free amino acids by weight of proteinaceous matter.

It was found to be advantageous to pre-ferment a substrate before inoculation of the substrate with a fungus and preferably even before heat-deactivation of the substrate as mentioned as step a in claim 1. Prefermentation should preferably occur with a micro-organism from the genus Bacillus or Lactobacillus and in particular with Bacillus subtilis or Bacillus badius for a period of at least 2 hours. During said fermentation significant amounts of lactic acid are formed, preferably reducing the pH to below 5.2, more preferably to below 4.8 and most preferably below 4.2. Such a low pH has the advantage that it hampers bacterial growth but does not seriously inhibit growth of the fungi applied in accordance with the present invention. Preferably, during the fermentation step c) the pH does not exceed 5.5 for more than 6 hours, more preferably it does not exceed 5.5 for more than 3 hours. Although it is possible to acidify the substrate prior to the inoculation with fungus through the addition of an acidulant, it was found that the pre-fermentation with Bacillus or Lactobacillus is more effective in hampering subsequent bacterial growth during fermentation with a fungus.

It was surprisingly found that the powder product obtained by the present process, when administered orally, retains its effectiveness against diarrhea despite prolonged intimate contact with the gastric juices. This is why the present product does not need to be coated or otherwise protected to survive the residence time in the stomach.

Another aspect of the present invention is a composition for use in a method of treating diarrhea, especially traveller's diarrhea, weaning diarrhea and toxine-associated diarrhea (cholera, E. coli), abdominal pains and cramps, wherein said method comprises administering an effective amount of a powder obtained by the process as described above.

In a preferred embodiment of the invention the composition is used in a method which comprises administering, on a daily basis, the powder in an amount which is equivalent to between 0.1 and 50 g and preferably between 0.5 and 10 g of the bigger than 5 kD portion of the same powder. The latter composition preferably comprises separate dosage units that are suitable for at least once daily administration. Administration of amounts in excess of the amount given above are not disadvantageous and retain the beneficial effect of the process and the composition of the invention.

The powder obtained from the process according to the invention can suitably be combined with other components that can advantageously be used to (prophylactically) treat diarrhea. Accordingly, in a preferred embodiment, the present composition further comprises probiotics, yeasts, glucose, glucose-saccharides (starch, maltodextins) and/or minerals. Probiotics can include Bifidobacterium species, Lactobacilli Pediococci, Propionibacteria, Enterococcus faecium, Leuconostoc strains, or mixtures thereof, all in an amount of at least 10⁷ viable cells per g of total product. Yeasts can be included as non-viable (including dead) cells or viable cells or mixtures thereof. Effective yeast species include Saccharomyces cerevisae and S. boulardii, which are preferably included in an amount of 0.5-5 g as is disclosed in WO 00/33854.

### EXAMPLE 1

Soy Fermentation

Soy was fermented as described by Kiers et al., “In vitro digestibility of processed and fermented soya bean, cowpea and maize”, J. Sci. Food Agriculture, 80, 1325 (2000). Rhizopus microsporus var oligosporus was grown on malt extract agar (Oxoid, CM 59). A sporangiospore solution was obtained by scraping off the sporangia from a slant culture after 7 days incubation of the above described micro-organisms at 30° C. and suspending them in sterile distilled water with 0.85% NaCl and 0.1% peptone. The viable count varied between 10⁵ and 10⁶ colony-forming units per ml (cfu/ml) when determined on Rose-Bengal Chloramphenicol Agar (Oxoid, CM 549).

Dehulled yellow-seeded soybeans (Glycine max) were soaked overnight in tap water during three cycles of accelerated acidification (Nout et al., Food Microb. 4, 1987, 165-172). Subsequently the beans were washed with tap water, cooked in fresh tap water for 20 minutes (ratio beans:water of 1:3), cooled and superficially dried at room temperature. The beans were inoculated with the sporangiospore suspension (1% v/w) and packed into hard-plastic, perforated boxes (205×90×45 mm) and incubated at 30° C. Each box contained 450 g of inoculated beans. After 44 hours the fermented product was dried in an oven at 50° C. overnight, ground and sieved over a 1 mm sieve.

In Vitro Digestion of Fermented Soy

The digestion was done as described by Kiers et al. Samples (100 g) of fermented soy were suspended in distilled water (600 ml). The samples were incubated while stirring with an α-amylase solution (40 ml) consisting of 12.500 units/l α-amylase (Sigma A-1 031), 1.5 g/l NaCl, 1.5 g/l K₂HPO₄ and 0.5 g/l Na₂CO₃ (pH 7.0) for 30 min. at at 37° C.

Next the pH was adjusted to 4.0 using 5M HCL and the suspensions were incubated with 160 ml of stomach medium [0.1 g/l lipase (Amano Pharmaceuticals, Rhizopus F-AP15), 0.125 g/l pepsin (Sigma P-6887), 3.1 g/l NaCl, 1.1 g/l KCl, 0.6 g/l Na₂CO₃, 0.11 g/l CaCl₂, pH 4.0] for 1 h at 37° C. The pH was adjusted to 6.0 using solid NaHCO₃. Finally, 200 ml of a 2% pancreatic solution (20.0 g/l pancreatin (Sigma P-1750), 5.0 g/l bile (Sigma B-3883), 5.0 g/l NaCl, 0.68 g/l KH₂PO4, 0.3 g/l Na₂HPO4, 0.84 g/l NaHCO₃) was added and the suspensions were incubated for 30 min. at 37° C. (pre-digested fermented soy fraction).

Fractionation of Pre-Digested Fermented Soy

The pre-digested fermented soy suspensions were centrifuged at 3000×g for 15 min. at 4° C. The supernatant was carefullly decanted and the pellet was restored to its original volume with distilled water (Pellet fraction). The supernatant was consecutively filtered over celite, an 8 μm filter and a 5 μm filter before it was passed over a 0.22 μm filter. Subsequently the filtrate was filtered over an ultrafiltration membrane with a molecular weight cut-off of 5000 Dalton (Koch Spiral module S2k238). Both retentate and filtrate were collected and were brought back to their original volume with dilution or rotational evaporation at low temperature (40-50° C.), giving a >5 kD fraction and a <5 kD fraction.

Small Intestinal Segment Perfusion (SISP)

SISP was performed as described by Nabuurs, M. J., Hoogendoorn, A., van Zijderveld, F. G. et al. A long-term perfusion test to measure net absorption in the small intestine of weaned pigs. Research in Veterinary Science 1993; 55: 108-114.

Piglets (crossbred Yorkshire x (Large White x Landrace)) were weaned at three weeks of age. They were transported to the institute and fed a standard piglet feed. Water containing 60 mg/ml colistin sulphate was applied ad libitum. About two weeks after weaning biopts from the duodenal mucosa were taken using a fiberscope (Olympus GIF XP10, Olympus, Hamburg, Del.) and receptor status was determined essentially according to Sellwood et al. (Selwood R, Gibbons R A, Jones G W, “Adhesion of enteropathogenic Escherichia coli to pig intestinal brush borders: the exisence to two pig phenotypes”, J. Med Microbiol. 1975, 8, 405-411. Piglets that expressed the receptor (K88/F4) involved in binding of the ETEC strain were used in the experiment three weeks after weaning.

The anaesthetic and surgical procedures used were essentially as described by Nabuurs et al., “A long-term perfusion test to measure net absorption in the small intestine of weaned pigs, Res. Vet. Sci., 55 108 (1993). The animal was tranquillised with 2 mg/kg body weight azaperon. Anaesthesia was induced with halothanum and nitrous-oxide. The abdominal cavity was opened and the first intestinal segment was prepared approximately 75 cm caudal from the stomach. A small cranial tube (inflow) was placed and a wide tube (outflow) was placed 20 cm distal from the first. Caudal and adjacent to this first segment nine other segments were prepared in the same way. In this way the ten segments were situated between 9.0±1.7−34.2±4.1% of the total length of the small intestine. Between segments 2-3, 5-6, and 8-9, 2 cm pieces of the intestine were removed for measurement of the circumference as described before (Nabuurs et al.). The odd numbered segments were injected with 5 ml enterotoxic E. coli (ETEC) (5×10⁹ colony forming units O149:K91: K88ac, producing heat-labile and heat-stabile toxin STb) and the even numbered segments with 5 ml phosphate-buffered saline (PBS), whereupon the segments were perfused during 8 hours. Saline (supplemented with 0.1% glucose and 0.1% casamino acids), pre-digested fermented soy bean, the pellet fraction, the >5 kD fraction and the <5 kD fraction (for description of the fractions see above) were tested in three experiments of four piglets. In each piglet, five pairs of segments (an uninfected and an adjacent ETEC-infected) were perfused using Latin square design for the four soy bean products and fractions with saline in the middle (segment 5 and 6). Each segment was perfused with 64 ml of product over 8 hours, by injecting 2 ml of product every 15 minutes. At the end of the experiment the product remaining in the segments was blown out into the drainage bottles.

The piglets were killed by injection of 200 mg/kg body weight sodium pento-barbital. The segments were cut from the mesenterium and the length was measured (see Nabuurs et al.). Samples of 1 cm were cut from the segment and put into physiological salt solution. Decimal dilution series were made and appropriate dilutions were spread on heart infusion agar (Difco 0044-17-9) supplemented with 5% of defibrinated sheep blood. Plates were incubated for 18-24 hours at 37° C. and haemolytic colonies were counted.

Net fluid, dry matter, sodium, potassium and chloride adsorption was calculated from the difference between the volume and concentration of inflow and outflow divided by the surface area (length times circumference) of the segment (see Nabuurs et al. (1993), and Nabuurs et al., “Effects of weaning and enterotoxigenic Escherichia coli on net absorption in the small intestine of pigs”, Res. Vet. Sci., 56, 379 (1994)). The net absorption of fluid, dry matter, sodium, potassium and chloride was determined as the mean±standard error of the mean of the 12 piglets. Results were analysed using one-way analysis of variance (ANOVA) using Turkey's multiple comparison test when overall p<0.05. Comparison in case of results obtained from uninfected vs. ETEC-infected segments for one product were made by paired t-test.

TABLE 1
Net fluid uptake (ml/cm²) after perfusion
with the pre-digested soy bean products.

| | Without ETEC | With ETEC |
|---|---|---|
| | infection | infection |
| ORS | 0.8 | 0.3 |
| Soy fermentate | 0.6 | 0.6 |
| Pellet | 1.0 | 0.6 |
| Fraction > 5 kD | 1.2 | 1.0 |
| Fraction < 5 kD | 1.0 | 0.6 |

The differences in fluid absorption with and without ETEC-infection are presented in table 1 per product. It is clear that with pre-digested fermented product there is no difference in net fluid uptake between infected and non-infected segments. This shows that the fermented product can inhibit ETEC-infection induced secretion of fluid. The pellet fraction and <5 kD fraction do not show inhibition of fluid secretion, whereas the >5 kD fraction does. This shows that the inhibiting compound is soluble and larger than 5 kD.

### EXAMPLE 2

A fermentation of soybeans was carried out as described in example 1. Of the resulting product 100 grams were suspended in 600 ml distilled water and stirred for 1 hour at 37° C. The suspension was centrifuged at 3000×g for 15 minutes and further fractionated into a pellet fraction, a >5 kD fraction and a <5 kD fraction as described in example 1.

The >5 kD fraction was separated into two fractions of equal volume. One of these >5 kD fractions was boiled for 30 minutes at 100° C. to inactivate enzymes (proteases and α-galactosidase), the other was kept untreated. These fractions (boiled fraction, untreated fraction) were used in binding assay described below. Before the assay the protease and glycosidase activity was measured in the non-inactivated fractions (>5 kD). The following results were thus obtained:

TABLE 2
Protease and glycosidase activities (U/g)

| | | | | β- |
|---|---|---|---|---|
| protease | α-galactosidase | β-galactosidase | α-glucosidase | glucosidase |
| 30 | 4500 | 1500 | 300 | 300 |

The aforementioned fractions were used to measure inhibition of pathogen binding to humane carcinogenic colon cells (Caco-2, ATCC, Maryland, P17 to P33). Cells for the binding experiment were grown under standard conditions in a 12-wells plate. In each well, the growth medium was removed and 0.2 ml of minimal essential medium, 0.4 ml ETEC solution (2×10⁸ cfu/ml) and 0.4 ml of test solution (fractions described above) is added. Appropriate controls (positive and negative) were used. Cells were incubated for an hour at O0C, after which the medium was removed. The cells were washed five times with PBS buffer, lysed, homogenised, diluted and plated to count colony-forming units, following standard procedures. Comparison of the amount of cfu's found with the blank and with one of the fractions, the inhibiting power of the fraction can be calculated as percentage reduction in binding.

In a separate experiment the cells were first incubated with fermented soy solution (0.4 ml 37° C. 30 minutes), the cells were washed after which the ETEC solution (0.4 ml, 2×10⁸ cfu/ml) was added.

TABLE 3
Percentage reduction in binding of ETEC to Caco2 cells

| | Boiled | Not boiled |
|---|---|---|
| Addition of fermented soy | 53 | 75 |
| and ETEC to cells | | |
| Pre-incubation with | 2 | 25 |
| fermented soy | | |

From the Above Results the Following Conclusions May be Drawn:

1. Heat treatment causes reduction of the capacity of inhibiting binding

2. Although heat treatment significantly reduces binding inhibition, some activity still remains after heat treatment

3. The active components operate primarily through some form of interaction with the bacterial cells.

1. Process for the manufacture of a health promoting product, said process comprising the subsequent steps of:
a) preparing a pasteurised or sterilised substrate containing from 30 to 60 wt. % dry matter of which at least 50 wt. % is derived from a plant material selected from the group consisting of legume, pulses, fruit, nuts, beans, seeds, grain, tubers and mixtures thereof, said substrate containing between 7.5 and 70% protein, between 20 and 67% carbohydrates and between 0 and 40% lipids by weight of dry matter,
b) inoculating said substrate with a fumgus from a genus selected from the group consisting of Rhizopus, Aspergillus, Mucor, Penicillium, Alomyces, Absidia and Syncephalastrum,
c) allowing the fungus to ferment the substrate for at least 6 hours at a temperature in excess of 25° C.,
d) isolating an aqueous fraction from the fermentate so obtained,
e) drying said aqueous fraction so as to obtain a powder which expresses at least 10 U/g of protease activity.

2. Process according to claim 1, wherein the fungus is selected from the group consisting of Rhizopus microsporus, Rhizopus stolonifer, Rhizopus oryzae, Aspergillus niger, Mucor javanicus and Mucor indicus.

3. Process according to claim 1 or 2, wherein the plant material is pulses.

4. Process according to claim 3, wherein the plant material is selected from the group consisting of soybean, cowpea and mixtures thereof.

5. Process according to any one of claims 1-4, wherein the substrate contains less than 5 wt. %, preferably less than 2 wt. % sodium chloride.

6. Process according to any one of claims 1-5, wherein the dried aqueous fraction contains from 35 to 90 wt. % proteinaceous matter, from 10 to 45 wt. % carbohydrates, less than 8 wt. % lipids and less than 10 wt. % water.

7. Process according to claim 6, wherein the bigger than 5 kD portion of the dried fraction represents at least 15 wt. % of said dried fraction

8. Process according to any one of claims 1-7, wherein the isolation step d) includes the application of a filter with a molecular weight cut-off point of at least 3 kD.

9. Process according to any one of claims 1-8, wherein the dried aqueous fraction expresses at least 4.5 U/mg of α-galactosidase activity.

10. Process according to any one of claims 1-9, wherein the substrate is pre-fermented with a microorganism from the genus Bacillus or Lactobacillus for at least 2 hours prior to step b).

11. Composition suitable for use in a method of treating diarrhea, abdominal pains or cramps in a human or animal, wherein said composition is obtainable by a process according to any one of claims 1-10.

12. A method of treating diarrhea, abdominal pains or cramps in a human or animal, wherein said method comprises administering an effective amount of the composition of claim 11.
